(19) United States
(12) Patent Application Publication
(10) Pub. No.: US 2012/0156353 A1
(43) Pub. Date: Jun. 21, 2012

(54) LIQUID FORMULATION CONTAINING PROTEIN AND LAMBDA CARRAGEENAN FROM HALYMENIALES

(75) Inventors: Christopher J. Sewall, Hope, ME (US); William R. Blakemore, Topsham, ME (US); Erick I. Ask, Milton, MA (US)

(73) Assignee: FMC CORPORATION, Philadelphia, PA (US)

(21) Appl. No.: 13/315,559

(22) Filed: Dec. 9, 2011

Related U.S. Application Data
(60) Provisional application No. 61/459,764, filed on Dec. 17, 2010.

(51) Int. Cl. A23J 3/22; A23C 9/154; A23L 1/305; A23C 9/156; A23C 11/10; A23G 9/42; A23L 2/66; A23C 9/137

(52) U.S. Cl. 426/565; 426/656; 426/590; 426/580; 426/583; 426/584; 426/598; 426/648

(57) ABSTRACT

A liquid formulation comprising protein and lambda carrageenan, wherein the lambda carrageenan comprises lambda carrageenan from at least one seaweed of the taxonomic order Halymeniales.

### FIELD OF THE INVENTION

The present invention is directed to a liquid formulation comprising protein and lambda carrageenan, wherein the lambda carrageenan comprises lambda carrageenan from at least one seaweed of the taxonomic order Halymeniales.

### BACKGROUND OF THE INVENTION

Protein containing beverages are very different from non-protein containing beverages and have their own unique set of challenges. In the protein-containing beverage market (e.g., milk, chocolate milk, etc.), there is a trend toward reducing solids content of the overall system. This could be for cost reduction and/or health reasons. Typically, when the solids levels of such liquid formulations are reduced, the resulting beverage will exhibit deficiencies such as lack of body, mouthfeel, or stability.

Carrageenan is a commonly used thickener and stabilizer in beverages such as chocolate milk. However, carrageenan can be unacceptably reactive with proteins. The protein is a high molecular weight charged molecule (with positive and negative charges) wherein the positive sites will directly bond with the negative ester sulfate sites on the carrageenan (carrageenan is only negative charged from ester sulfate), so the molecular make-up of the carrageenan is important in determining the degree of interaction with the protein and therefore degree of gelation. In addition, the negative sites on the protein can be linked with the negative sites on the carrageenan through calcium cations (salt bridge). Both of these interactions determine the degree of interaction and gelation of the lambda carrageenan with the protein in the system. Normally, the concentration of carrageenan, including traditional lambda carrageenan, required to restore the mouthfeel to consumer acceptable levels will cause gelation of the liquid formulation due to the increased and excessive reactivity between the carrageenan and the protein in the beverage. There is a demand for protein-containing liquid formulations having reduced solids (e.g., reduced sugar chocolate milk), but the resulting mouthfeel needs to be restored to consumer acceptable levels. For example, reduction of the sugar solids in chocolate milk causes the mouthfeel to become too “thin” or “watery.”

Briones, et al, “USP Grade Lambda-Like Carrageenan From Halymenia Durvillaei Bory De Sainte Vincent” discloses the use of lambda carrageenan from Halymenia durvillaei and teaches that such is non-gelling in a water (non-protein containing) environment. However, there is no teaching in Briones regarding the interaction, thickening, or gelling ability of the specific lambda carrageenan in a protein-containing system.

### SUMMARY OF THE INVENTION

The lambda carrageenan from Halymeniales has been found to be useful in protein-containing beverages at amounts that successfully provide stability and restore mouthfeel without gelation. Since the lambda carrageenan of the present invention has been found to be not as reactive with protein as other lambda carrageenans, the lambda carrageenan of the present invention can be used at higher concentrations without any deleterious effects (e.g., from gelation) and provide a wider range of mouthfeel restoration and stability.

The present invention is directed to a liquid formulation comprising protein and lambda carrageenan, wherein the lambda carrageenan comprises lambda carrageenan from at least one seaweed of the taxonomic order Halymeniales.

### BRIEF DESCRIPTION OF THE DRAWINGS

FIGS. 1-4 are graphs showing the viscosity of Formulations A-D as described in Example 1 at various concentrations and times (e.g., from two week data (FIG. 1) to three month data (FIG. 4)).

### DETAILED DESCRIPTION OF THE INVENTION

Mouthfeel is a term in the liquid formulation field that describes a liquid formulation having appropriate stability, thickness, and texture. Mouthfeel can be negatively impacted by the decrease in solids content such as protein, fat, sweetener, etc., and the lambda carrageenan of the present invention enables reduced levels of solids yet still provides a liquid having acceptable mouthfeel and stability without the gelation over a wide use level.

The present invention is directed to a liquid formulation comprising protein and lambda carrageenan, wherein the lambda carrageenan comprises lambda carrageenan from at least one seaweed of the taxonomic order Halymeniales. The lambda carrageenan may be from at least one algal family comprising Halymeniaceae or Tsenglaceae. The seaweed may be from at least one genus comprising Halymenia, Grateloupia, or Tsenglia. The seaweed may be from at least one algal species comprising Halymenia durvillei, Halymenia floresii, Halymenia fimbriata, or Grateloupia filicina. Additional basionym species of Halymenia durvillei include Halymenia formosa, Halymenia fimbriata, and Halymenia microcarpa; additional basionym species of Halymenia floresii include Halymenia venusta; and additional basionym species of Grateloupia filicina include Grateloupia subpectinata, Grateloupia conferta, Grateloupia porracea, Grateloupia filiformis, Grateloupia catenata, and Grateloupia prolongata.

The lambda carrageenan from Halymeniales has a different chemical structure than other traditional commercial sources of lambda carrageenans. For example, lambda carrageenan from traditional commercial sources such as Chondrus crispus, Gigartina skottsbergii, and Sarcothalia crispata have exclusively a D-galactan molecular backbone structure (with no L-galactose present). Compared to such traditional lambda carrageenans, the lambda carrageenan from Halymeniales has less ester sulfate content, more pyruvate content, increased methyl content and the presence of L-galactose (with D-galactose forming a DL-hybrid galactan molecular backbone). In regard to the lambda carrageenan from Halymeniales, the pyruvate ester, methyl ester, and L-galactose distribution appear to be random along the molecular backbone, but each are associated with specific carrageenan moieties. The pyruvate is present as galactose-2-sulphate-4:6-pyruvate, the methyl as galactose-6-methyl, and the L-galactose as unsulphated 3:6-anhydrogalactose. In addition, the ester sulphate content of carrageenans ranges from 18-40%. The lambda carrageenan from Halymenia durvillei has been found to have an ester sulphate content in the range 26-34% as compared to regular lambda carrageenans having an ester sulphate content in the range of 34-40%. The lambda carrageenan from Sarcothalia crispata is the closest in nature to the ideal structure for lambda carrageenan as detailed in the literature, and, hence, it is commonly used as a reference material when assessing the functionality of various lambda carrageenans. The ester sulphate content in the lambda carrageenan from Halymenia durvillei is lower at 32-36% when compared to the content in Sarcothalia crispata of 38%.

The lambda carrageenan from any one or combination of seaweeds from Halymeniales comprises at least 75%, at least 90%, at least 95% and at least 100% of all lambda carrageenan in the liquid formulation of the present invention.

The liquid formulation of the present invention includes any reduced fat, reduced sweetener, and reduced solids formulations thereof. The liquid formulations can include beverages, soft serve ice cream formulations, cream liquors, coffee creamers, and UHT creams, as well as any reduced fat, reduced sweetener and reduced solids versions thereof. Examples of beverages include those that are or contain milk, milkshakes, yogurt, fruit, egg nog, fermented milk, and soy milk, as well as any reduced fat, reduced sweetener or reduced solids versions thereof. Examples of milk include chocolate milk, strawberry milk, and banana milk, as well as any reduced fat, reduced sweetener or reduced solids versions thereof. The milk that can be used in the present invention can be from any source including cows and goats.

When the liquid formulation is a beverage (e.g., a drinkable liquid suitable for human consumption), the lambda carrageenan may be present in an amount of from 0.01% to 0.5% by weight of the beverage, the total solids content from protein may be from 1 to 10 wt % by weight of the beverage, the total solids content from sweetener may be from 0 to 30 wt % by weight of the beverage, and the total solids content from fat may be from 0 to 15.0 wt % by weight of the beverage.

When the beverage is or contains milk, the lambda carrageenan may be present in an amount of from 0.01 to 0.2 wt % by weight of the milk, the total solids content from protein may be from 1 to 4 wt % by weight of the milk, the total solids content of sweetener may be from 0 to 8 wt % by weight of the milk, and the total solids content from fat may be from 0 to 4 wt % by weight of the milk. More particularly, the total solids content of sweetener may be from 0 to 5 wt % by weight of the milk, more particularly, from 0 to 4%, or from 0 to 3% by weight of the milk. Examples of such milk formulations include chocolate milk, strawberry milk and banana milk.

The sweetener useful in any of the milks of the present invention includes any of sucrose, dextrose, and fructose. Artificial sweeteners include sucralose, aspartame, and saccharin.

The liquid formulation of the present invention may further comprise a food, nutraceutical active ingredient or pharmaceutical active ingredient.

The lambda carrageenan from the Halymeniales seaweed may be recovered and used herein in any known technique. For example, recovery methods of carrageenan from Halymeniales include optional whole or partial filtration of insolubles from the starting seaweed or the use of unfiltered seaweed or extruded seaweed. An extraction example includes adding the seaweed to hot dilute alkali to solubilize the lambda carrageenan, removing the solids by centrifugation and/or filtration, dewatering by evaporation, and/or alcohol precipitation, and/or spray drying, and grinding the extracted lambda carrageenan to a fine powder. The seaweed may also be cultivated as necessary or desired. As a result, lambda carrageenan from any Halymeniales that is wild or cultivated may be used in the present invention. Any known techniques for cultivating the Halymeniales seaweed can be used. Examples of cultivation techniques include open-ocean fanning and land-based tank culture.

The present invention is now described in more detail by reference to the following examples, but it should be understood that the invention is not construed as being limited thereto. Unless otherwise indicated herein, all parts, percents, ratios and the like are by weight.

### EXAMPLES

### Example 1

Chocolate milk was prepared using various lambda carrageenans in reduced sugar formulations and compared to a chocolate milk formulation containing a highly functional microcrystalline cellulose/carboxymethyl cellulose (MCC/CMC) stabilizer and an amount of sugar that is typical (i.e., not reduced) in a chocolate milk formulation. This chocolate milk formulation was used as a control (“Control”) given its ideal characteristics in typical amounts of sugar and solids formulations. This study was performed to determine if the formulations using various lambda carrageenans in reduced sugar amounts could produce a chocolate milk formulation that is comparable to the Control (the Control using typical amounts (i.e., not reduced) of sugar).

The Control formulation is as follows:

| | |
|---|---|
| Milk - 1% Fat | 90.75% |
| Water | 0.00% |
| Sugar | 7.50% |
| Cocoa Powder - Cocoa Berry 10-12% Fat | 1.50% |
| MCC/CMC | 0.25% |

The reduced sugar formulations (A-D) are as follows.

Formulation A

| Milk - 1% Fat | To 100% |
|---|---|
| Water | 3.75% |
| Sugar | 3.75% |
| Cocoa Powder - Cocoa Berry 10-12% Fat | 1.50% |
| Commercial Lambda Cgn Containing Product | 0.02%-0.10% |

Formulation A used a commercial product sold by FMC Corporation (as a relatively non-gelling, lambda carrageenan containing, stabilizer) typically containing about 70% native kappa-2 carrageenan and 30% lambda. The lambda carrageenan in the commercial product is from Gigartinales.

Formulation B

| Milk - 1% Fat | To 100% |
|---|---|
| Water | 3.75% |
| Sugar | 3.75% |
| Cocoa Powder - Cocoa Berry 10-12% Fat | 1.50% |
| Lambda Carrageenan of Invention | 0.02%-0.20% |

The lambda carrageenan used in Formulation B was extracted from cultivated Halymenia durvillei.

Formulation C

| Milk - 1% Fat | To 100% |
|---|---|
| Water | 3.75% |
| Sugar | 3.75% |
| Cocoa Powder - Cocoa Berry 10-12% Fat | 1.50% |
| Lambda Carrageenan of Invention | 0.02%-0.20% |

The lambda carrageenan used in Formulation C was extracted from “wild” Halymenia durvillei.

Formulation D

| Milk - 1% Fat | To 100% |
|---|---|
| Water | 3.75% |
| Sugar | 3.75% |
| Cocoa Powder - Cocoa Berry 10-12% Fat | 1.50% |
| Lambda Carrageenan from S. crispata | 0.02%-0.10% |

The lambda carrageenan used in Formulation D comprises essentially all lambda carrageenan (i.e., about 95-98% lambda carrageenan and about 2-5% kappa-2 carrageenan). The lambda carrageenan is extracted from Sarcothalia crispata.

Each formulation was prepared by dry blending the stabilizer (the MCC/CMC and lambda carrageenans products) with the sugar and cocoa powder. Each dry blend was then added to 1% (fat) milk using a lightning mixer at 1250 rpm. The mixture was allowed to mix for 30 minutes. The product was then preheated to 185° F. followed by a final heat treatment of 284° F. for 6 seconds. The product was then cooled to 160° F. and homogenized in two stages (2500 psi, 500 psi). Finally, the mixture was cooled to 70° F., filled into 250 ml sterile PETG (Polyethylene Terephthalate Glycol) bottles, and transferred to a refrigerator.

Each product was evaluated after 2 weeks, 1 month, 2 months, and 3 months refrigerator storage for pour viscosity, pour quality, and mouthfeel as follows. Viscosity: each sample was poured into a 300 mL glass beaker and tested at about 4° C. using a LVT viscometer, spindle #1 at 60 rpm for 10 seconds. Pour Quality: samples were poured, observed for interruption in flow, and classified according to the degree of gelation as follows.

Smooth Pour—No gelation is present. A uniform pour is noticed throughout the duration of the pour.

Ripple—Light ripple is subtle interruption in flow, apparent as beverage begins to flow. It may smooth out as pouring continues. This is typically acceptable to the consumer. “Ripple” is indicative of a very weak gel structure and “Heavy Ripple” is more pronounced interruption in flow and continues as the beverage is poured. This is an unacceptable defect and gives consumers the appearance of spoilage.

Blurp—This is a more distinct coherent gel than ripple, with a pudding-like consistency when poured from the bottle. Large pieces of soft gel throughout that create ‘blurp’ as they fall from the bottle.

Gelled—Most of the product in the bottle is soft gel or worse and remains in the bottle upon pouring.

Finally, the mouthfeel of each sample was compared to the mouthfeel of the Control and given a rating on a scale of 1-5 as follows: 1=unacceptable, very thin; much less than Control; 2=unacceptably thin, less than Control; 3=acceptable, equal to or slightly thinner than Control; 4=unacceptably thick, thicker than Control; and 5=unacceptable, very thick, much thicker than Control.

The results are as follows:

| | | 2 weeks | | | 1 month | | |
|---|---|---|---|---|---|---|---|
| Stabilizer | Use level (%) | Viscosity (cP) | Pour Observations | Mouthfeel | Viscosity (cP) | Pour Observations | Mouthfeel |
| Formulation A | 0.02 | * | smooth | 1 | 8.5 | smooth | 1 |
| Formulation A | 0.04 | * | smooth | 1 | 12.0 | smooth | 2 |
| Formulation A | 0.06 | 62.5 | Light Ripple | 4 | 68.5 | Heavy Blurp | 4 |
| Formulation A | 0.08 | 102.5 | Light Ripple | 5 | 122.5 | Heavy Blurp | 5 |
| Formulation A | 0.1 | 170 | Ripple | 5 | 172.5 | Heavy Blurp | 5 |
| Formulation B | 0.02 | * | smooth | 1 | 7.5 | smooth | 1 |
| Formulation B | 0.04 | * | smooth | 2 | 8.5 | smooth | 2 |
| Formulation B | 0.06 | 13 | smooth | 3 | 15.0 | smooth | 3 |
| Formulation B | 0.08 | 18 | smooth | 3 | 20.5 | smooth | 3 |
| Formulation B | 0.1 | 29 | smooth | 3 | 41.0 | smooth | 3 |
| Formulation B | 0.15 | 57.5 | smooth | * | 47.5 | Light Blurp | * |
| Formulation B | 0.2 | 82.5 | smooth | * | 105.0 | Light Blurp | * |
| Formulation C | 0.02 | * | smooth | 1 | 7.5 | smooth | 1 |
| Formulation C | 0.04 | * | smooth | 2 | 8.5 | smooth | 2 |
| Formulation C | 0.06 | 12 | smooth | 3 | 15.0 | smooth | 3 |
| Formulation C | 0.08 | 19 | smooth | 3 | 27.0 | smooth | 4 |
| Formulation C | 0.1 | 38 | smooth | 3 | 35.8 ** | smooth | 4 |
| Formulation C | 0.15 | 64.0 | smooth | * | 57.5 | Light Blurp | * |
| Formulation C | 0.2 | 100.0 | smooth | * | 92.5 | Light Blurp | * |
| Formulation D | 0.02 | 7.0 | smooth | * | 10.5 | smooth | * |
| Formulation D | 0.04 | 25.0 | smooth | * | 40.5 | smooth | * |
| Formulation D | 0.06 | 45 | Light Ripple | 4 | 54.0 | Light Blurp | 4 |
| Formulation D | 0.08 | 107.5 | Ripple | 5 | 105.0 | Blurp | 4 |
| Formulation D | 0.1 | 152.5 | Ripple | 5 | 135.0 | Heavy Blurp | 4 |
| | | 2 months | | | 3 months | | |
| Stabilizer | Use level (%) | Viscosity (cP) | Pour Observations | Mouthfeel | Viscosity (cP) | Pour Observations | Mouthfeel |
| Formulation A | 0.02 | 9.5 | smooth | 1 | 10.5 | smooth | 1 |
| Formulation A | 0.04 | 19.5 | smooth | 1 | 19.5 | smooth | 1 |
| Formulation A | 0.06 | 64.5 | Heavy Blurp | 4 | 60.0 | Heavy Blurp | 4 |
| Formulation A | 0.08 | 127.5 | Heavy Blurp | 5 | 110.0 | Heavy Blurp | 5 |
| Formulation A | 0.1 | 172.5 | Heavy Blurp | 5 | 147.5 | Heavy Blurp | 5 |
| Formulation B | 0.02 | 9.0 | smooth | 1 | 9.0 | smooth | 1 |
| Formulation B | 0.04 | 18.0 | smooth | 1 | 11.0 | smooth | 1 |
| Formulation B | 0.06 | 22.5 | smooth | 3 | 20.0 | smooth | 3 |
| Formulation B | 0.08 | 30.0 | smooth | 3 | 27.5 | smooth | 3 |
| Formulation B | 0.1 | 35.5 | light ripple | 4 | 53.0 | light ripple | 4 |
| Formulation B | 0.15 | 98.0 | Light Blurp | * | 112.5 | Light Blurp | * |
| Formulation B | 0.2 | 135.0 | Light Blurp | * | 165.0 | Light Blurp | * |
| Formulation C | 0.02 | 7.0 | smooth | 1 | 9.0 | smooth | 1 |
| Formulation C | 0.04 | 11.0 | smooth | 1 | 10.0 | smooth | 1 |
| Formulation C | 0.06 | 20.0 | smooth | 3 | 14.0 | smooth | 3 |
| Formulation C | 0.08 | 22.5 | smooth | 3 | 23.5 | smooth | 3 |
| Formulation C | 0.1 | 55.5 | light ripple | 4 | 43.9 ** | light ripple | 4 |
| Formulation C | 0.15 | 72.0 | Light Blurp | * | 95.0 | Light Blurp | * |
| Formulation C | 0.2 | 130.0 | Light Blurp | * | 175.0 | Light Blurp | * |
| Formulation D | 0.02 | 13.0 | smooth | * | 15.0 | smooth | * |
| Formulation D | 0.04 | 43.0 | smooth | * | 42.0 | smooth | * |
| Formulation D | 0.06 | 56.0 | Blurp | 4 | 52.5 | Light ripple | 4 |
| Formulation D | 0.08 | 102.5 | Heavy Blurp | 4 | 110.0 | Heavy Blurp | 4 |
| Formulation D | 0.1 | 142.0 | Heavy Blurp | 4 | 137.5 | Heavy Blurp | 4 |

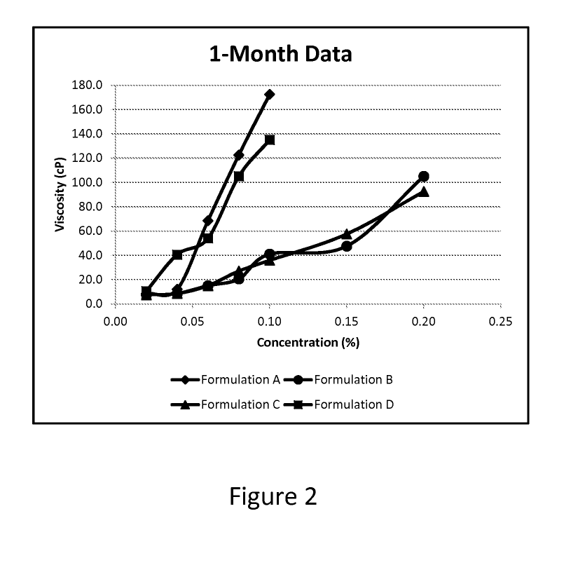

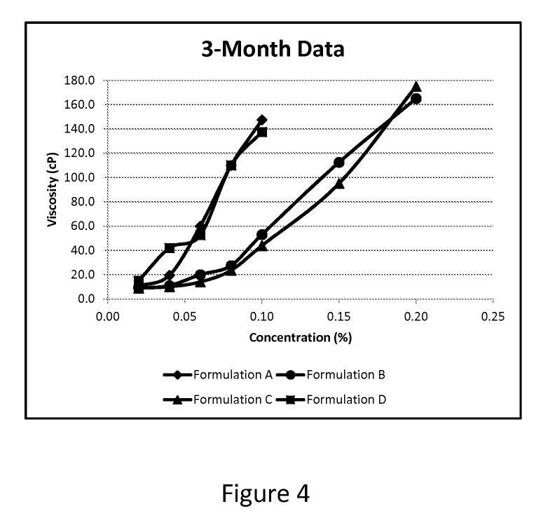

* sample not tested
** interpolated value based on the slope of the Figure in question (i.e., one month data is set forth in FIG. 2 and three month data is set forth in FIG. 4)

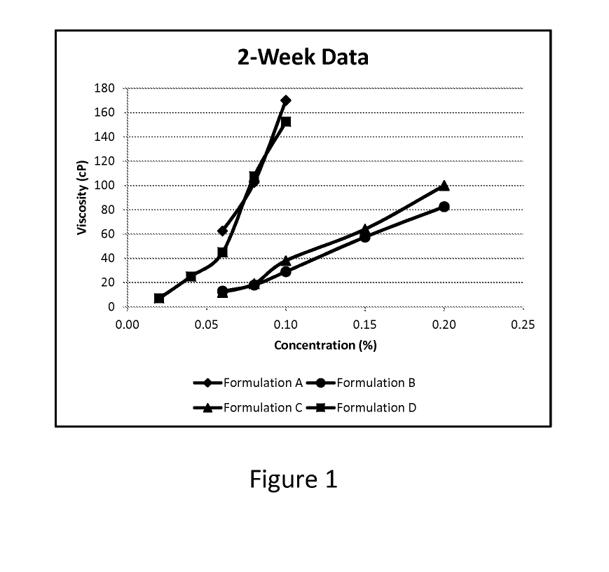

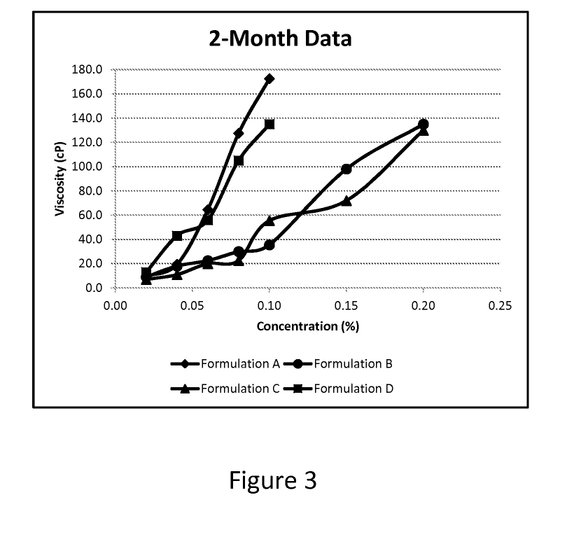

The foregoing results are illustrated in FIGS. 1-4 (showing the viscosity of Formulations A-D at various concentrations and times). For example, two week data is set forth in FIG. 1, one month data is set forth in FIG. 2, two month data is set forth in FIG. 3 and three month data is set forth in FIG. 4.

In the foregoing examples, it is shown that when an existing commercial product containing lambda carrageenan (i.e., Formulation A) was used to build back the viscosity due to solids reduction, the resulting beverage was unacceptable. The mouthfeel of the beverages made with the commercial lambda carrageenan of Formulation A was extremely sensitive to the usage level such that the mouthfeel moves from too thin to too thick as the usage level is increased by only 0.02%. For example, Formulation A at two weeks at 0.04% was unacceptably thin while at 0.06% was unacceptably thick. Visually, the beverage appearance changed from smooth to rippled appearance upon pouring. Formulation D was unacceptably thick at 0.06% and a change in appearance from smooth to rippled occurred when adjusting from 0.04 to 0.06%. The inventive materials on the other hand had an acceptable mouthfeel over a large range from 0.06 to 0.10%. The visual observation on pouring was smooth over a much greater range of 0.02 to 0.20% indicating a lack of gelation throughout this wide range. A wide range of acceptable use level is important in the industry as this allows formulators to produce an acceptable product even if there are small variations in either weighing ingredients or in quality of other ingredients in the system.

Another important requirement of reduced sugar chocolate milks is that the finished product maintains stability over time. After three months storage, the beverages using the inventive carrageenans still maintained an acceptable mouthfeel at a range of 0.06-0.08%. The pouring quality also maintained its smooth appearance over this three month period. The comparative examples exhibited a major change in pour appearance with Formulation A changing from light ripple to heavy blurp (gelation) and Formulation D changing from ripple to heavy blurp (gelation) at 0.08%. While not wishing to be bound by theory, the inventive carrageenan appears to be less reactive with milk protein, resulting in a broader functional use level range as well as better storage stability.

In summary, the inventive carrageenan: (i) was functional in beverages at 2 weeks, while the lambda carrageenan of Formulations A and D were not; (ii) provided acceptable mouthfeel without gelation over a broader range of use levels compared to beverages containing Formulations A and D; and (iii) provided a beverage that was stable up to at least three months.

While the invention has been described in detail and with reference to specific embodiments thereof, it will be apparent to one skilled in the art that various changes and modifications can be made therein without departing from the spirit and scope thereof.

What is claimed is:

1. A liquid formulation comprising protein and lambda carrageenan, wherein said lambda carrageenan comprises lambda carrageenan from at least one seaweed of the taxonomic order Halymeniales.

2. The liquid formulation of claim 1, wherein said liquid formulation is a beverage.

3. The liquid formulation of claim 2, wherein said beverage comprises at least one of milk, yogurt, fruit, egg nog, fermented milk, and soy milk.

4. The liquid formulation of claim 2, wherein said lambda carrageenan is present in an amount of from 0.01% to 0.5% by weight of the beverage, the total solids content from protein is from 1 to 10 wt % by weight of the beverage, the total solids content from sweetener is from 0 to 30 wt % by weight of the beverage, and the total solids content from fat is from 0 to 15.0 wt % by weight of the beverage.

5. The liquid formulation of claim 4, wherein said liquid formulation is milk and said lambda carrageenan is present in an amount of from 0.01 to 0.2 wt % by weight of the beverage, the total solids content from protein is from 1 to 4 wt % by weight of the beverage, the total solids content of sweetener is from 0 to 8 wt % by weight of the beverage, and the total solids content from fat is from 0 to 4 wt % by weight of the beverage.

6. The liquid formulation of claim 5, wherein said milk is chocolate milk, strawberry milk, or banana milk.

7. The liquid formulation of claim 5, wherein the total solids content of sweetener is from 0 to 5 wt %.

8. The liquid formulation of claim 7, wherein the total solids content of sweetener is from 0 to 4 wt %.

9. The liquid formulation of claim 1, wherein said Halymeniales comprises seaweed from the family Halymeniaceae.

10. The liquid formulation of claim 9, wherein said seaweed is from a genus of least one of Halymenia or Grateloupia.

11. The liquid formulation of claim 10, wherein said seaweed is from a species of at least one of Halymenia durvillei, Halymenia floresii, or Grateloupia filicina.

12. The liquid formulation of claim 11, wherein said species is Halymenia durvillei.

13. The liquid formulation of claim 1, wherein said liquid formulation is a soft serve ice cream formulation.

14. The liquid formulation of claim 1, further comprising a food, nutraceutical or pharmaceutical active ingredient.

15. The liquid formulation of claim 1, wherein said lambda carrageenan comprises at least 75% of lambda carrageenan from said seaweeds of the taxonomic order Halymeniales.

16. The liquid formulation of claim 15, wherein said lambda carrageenan comprises at least 90% of lambda carrageenan from said seaweeds of the taxonomic order Halymeniales.

17. The liquid formulation of claim 16, wherein said lambda carrageenan comprises at least 95% of lambda carrageenan from said seaweeds of the taxonomic order Halymeniales.

18. The liquid formulation of claim 17, wherein said lambda carrageenan consists of lambda carrageenan from said seaweeds of the taxonomic order Halymeniales.

19. The liquid formulation of claim 4, wherein said Halymeniales is Halymenia durvillei.

20. The liquid formulation of claim 5, wherein said Halymeniales is Halymenia durvillei.

21. The liquid formulation of claim 18, wherein said Halymeniales is Halymenia durvillei.

22. The liquid formulation of claim 5, wherein said lambda carrageenan consists of lambda carrageenan from said seaweeds of the taxonomic order Halymeniales.
